(19) United States
(12) Patent Application Publication
(10) Pub. No.: US 2006/0229898 A1
(43) Pub. Date: Oct. 12, 2006

(54) Methods and articles for facilitating software product implementation

(75) Inventor: Robert Seliger, Winchester, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sentillion, Inc., Andover, MA (US)

(21) Appl. No.: 11/109,284

(22) Filed: Apr. 19, 2005

Related U.S. Application Data
(60) Provisional application No. 60/668,932, filed on Apr. 6, 2005.

(51) Int. Cl. G06Q 99/00; G07G 1/14; G06Q 30/00

(52) U.S. Cl. 705/1; 705/14

(57) ABSTRACT

Methods and articles are provided which may be employed to establish a common understanding within a customer organization as to the business drivers that led to the purchase of a software product. In one embodiment, a method is provided which includes convening a session that includes members of the supplier and customer organizations. During the session, one or more facilitated exercises may be conducted to align the expectations of attendees from the customer organization with respect to the implementation effort. A series of exemplary articles which may provide a framework for the session, and which may engender discussion among session attendees, are disclosed.

### RELATED APPLICATIONS

This application claims priority under 35 U.S.C. § 119(e) to U.S. provisional application Ser. No. ______ having attorney docket number S1389.70020US00, entitled “METHODS AND ARTICLES FOR SOFTWARE PRODUCT IMPLEMENTATION,” filed on Apr. 6, 2005, having a serial number not yet assigned, which is incorporated by reference herein in its entirety.

### FIELD OF INVENTION

This invention relates to computer software products, and more particularly to the deployment and use of computer software products.

### BACKGROUND OF INVENTION

The process of selling complicated computer software products may be complex and time-consuming. Typically, representatives from the organization selling the product (i.e., the supplier organization) meet with representatives from a potential customer organization to discuss the customer's needs in detail, and the manner in which the product may meet those needs. Supplier representatives at various levels may meet with customer representatives at commensurate levels while attempting to sell the product. For example, executive-level representatives may meet to discuss the high-level business drivers for a potential purchase, and lower-level representatives may meet to discuss more detailed concerns, such as the compatibility of the product with other components in the customer's current computer or processing environment. Typically, authority to purchase a software product rests with the executive-level customer representatives.

### SUMMARY OF INVENTION

In one embodiment, a method is provided for facilitating a deployment of a software product. The method includes acts, performed after the software product has been sold by a supplier organization to a customer organization, of: (A) convening a group which includes at least one representative from the supplier organization and at least one representative from the customer organization, the at least one representative from the customer organization having an understanding of one or more executive level business goals that motivated the customer organization to purchase the software product; and (B) assessing, by the group, the one or more executive level business goals and ways in which the software product can be implemented at the customer organization to achieve at least some of the one or more executive level business goals.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart depicting an exemplary process for establishing a common understanding as to objectives for the implementation of a purchased software product, according to one embodiment of the invention;

FIG. 2 is a representation of an exemplary article which may be used to facilitate discussion on purchased software product functionality, according to one embodiment of the invention;

FIG. 3 is a representation of an exemplary article which may be used to facilitate discussion on business conditions at the time a software product is purchased, according to one embodiment of the invention;

FIG. 4 is a representation of an exemplary article which may provide a report of actual and planned progress on the implementation of a software product, according to one embodiment of the invention;

FIGS. 5A and 5B are representations of exemplary articles which may provide information on particular aspects of an software product implementation effort, according to one embodiment of the invention;

FIG. 6 is a representation of an exemplary article which may be used to facilitate discussion on dependencies and risks relating to a software product implementation effort, according to one embodiment of the invention; and

FIG. 7 is a representation of an exemplary article which may be used to facilitate discussion on best practices relating to a software product implementation effort, according to one embodiment of the invention.

### DETAILED DESCRIPTION

Once a sale of a software product is consummated, a supplier organization typically dispatches a representative to work with one or more members of the customer organization to develop a plan for implementing the product in the customer's processing environment. The implementation plan is typically very technical and detailed. As an example, an implementation plan may include, among other considerations, provisions for a physical site for the computer hardware on which the product will execute, a power source for the physical site, and networking equipment to establish communication between the physical site and the location(s) at which users are located. The members of the customer organization who are responsible for executing the implementation plan are generally not the same people who make the decision to purchase the product.

Applicants have appreciated that the implementation of a purchased software product may sometimes result in the software product being improperly or under-utilized because of a lack of understanding by individuals in the customer organization as to the reasons for the purchase of the product and/or the priorities for the implementation effort. For example, the members of the customer organization who are responsible for the implementation may not understand the high-level business drivers that led to the purchase of the product, and therefore may not account for these drivers properly in planning for or executing the implementation. This may, for example, be due to ineffective communication between members of the customer organization who approve the purchase and those who are responsible for implementation. For example, an executive may decide to purchase a product to satisfy a particular goal, such as compliance with an impending regulatory requirement or to address a security transgression, and may neglect to notify the implementation team of the goal, such that the team develops an implementation plan that does not properly achieve the goal. In another example, an executive may decide to purchase the product without performing an evaluation which involves members of the implementation team, such that the team is unsure of the product's value or fit within the processing environment. In yet another example, a substantial period may pass between the time of the purchase and the time at which the implementation effort gets underway, such that the circumstances that led to the purchase may no longer exist or may have changed.

Applicants have also appreciated that the interests of both the customer and supplier organizations are implicated by the implementation of a software product. For example, while it is clearly in the interest of the customer organization to maximize the value of the implemented product, it is also in the interest of the supplier organization to ensure that the product is properly and fully deployed and utilized, to engender goodwill with the customer organization and enhance the supplier organization's reputation in the marketplace.

Applicants have formulated a process for establishing a common understanding within the customer organization as to the reasons for the purchase of the product and the priorities which should govern its implementation. In the examples below, the process is described in connection with the deployment of software related to health care. However, the aspects of the invention described herein are not limited in this respect, as the process may be employed to facilitate the successful implementation of any suitable software product. In one embodiment, the process is initiated and driven by the supplier organization.

In one embodiment of the present invention, the process comprises convening an session which includes key members of the customer and supplier organizations. A session may, for example, include a facilitated review by the attendees of the business drivers for the purchase of the product, the high-level objectives for the implementation effort and the risks that the implementation effort may encounter. In one embodiment, the session may occur shortly before implementation is to occur, such that any changes in the business environment which may have occurred after the sale of the software product was consummated but before the implementation commences may be appropriately addressed in the implementation plan, although the invention is not limited in this respect.

A session may, for example, be led by a facilitator (e.g., an executive from the supplier organization) who guides and leads a discussion among session attendees, and may be focused on group interactive preparation of one or more articles. For example, the article(s) (e.g., one or more documents, files presentation slides, and/or other suitable work product(s)) may provide a framework for the discussion, and key points of the discussion may be captured and added to the articles. One type of article may, for example, be used to facilitate group discussion on the business drivers (e.g., the issues impacting the customer organization's business) which led to the purchase of the software product. Several exemplary articles are described in detail below.

Because key points of the discussion are captured therein, in one embodiment, an article may become an artifact of the session, and may be referenced by members of the customer and supplier organizations during the subsequent implementation effort. For example, a customer implementation team member may later review a particular artifact to confirm an agreed-upon plan for mitigating a particular risk, or a supplier representative may refer to an artifact to confirm an agreed-upon delivery date. In another example, artifacts may be used to educate non-attendees as to matters discussed, such as when the implementation team greets a new member. The new member may, for example, examine one or more of the artifacts to get a high-level understanding of the goals and priorities for the implementation effort. In this respect, artifacts may provide a succinct and useful summary of key points related to the product, and what the customer organization seeks to achieve through its implementation.

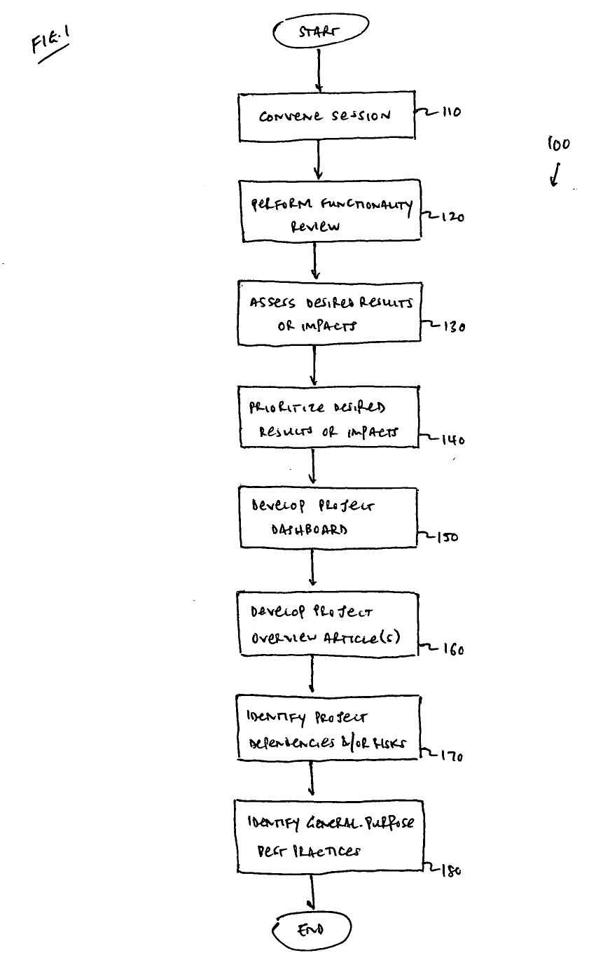

A flowchart depicting an illustrative process 100 for establishing an understanding in appropriate personnel in a customer organization with regard to key issues involving the purchase and deployment of a software product is shown in FIG. 1. Upon the start of the process, a session is convened in act 110. As described above, in one embodiment, the session may be facilitated, such that a session attendee may guide and/or lead the discussion.

In accordance with one embodiment, representatives from multiple levels of the customer organization (e.g., key business decision makers and IT personnel) may attend, so that a common understanding may be established within a customer organization. For example, in one embodiment, the session includes the member(s) who approved the product purchase, and those who will be responsible for its implementation. For example, having those responsible for the purchase decision state the reasons for that decision in the presence of the implementation team may assist the implementation team in deploying the system in a manner which achieves the desired high-level business goal.

Also, having attendees at multiple levels from both the customer and supplier organizations may promote relationship-building and dialogue between the organizations, which can serve to foster open communication between members of the organizations and make a successful implementation effort more likely. In one embodiment, if it is not feasible for customer representatives at multiple levels to attend, a priority is placed on ensuring that the key business decision makers (e.g., executives) attend. For example, decisions relating to the implementation effort may need to be made in the session, and having at least one executive-level attendee may ensure that a resource empowered to make a decision is present. Further, having executive-level attendees from both the supplier and customer organizations may facilitate knowledge sharing, which executives from both organizations may find beneficial. Furthermore, when the process is initiated at the request of the supplier organization, supplier executive-level attendance may make customer executives more likely to attend, as presence of the supplier executive(s) may lend credibility to the session and keep the discussion at a sufficiently high level that customer executives view the session as beneficial.

Upon convening the session in act 110, a functionality review is performed in act 120. In one embodiment, this portion of the session includes a review of the particular functionality of the software product purchased by the customer. The functionality review may be particularly useful when the software product has various functionality options which are available for purchase. Performing a functionality review may be useful for several reasons. First, one or more customer representatives may believe that particular product functionality was purchased when it was not. Thus, a functionality review may orient session attendees so that, for example, an attendee does not cite non-purchased functionality as a potential remedy for a business issue. Also, the customer may have purchased functionality which is not required to address the business issues at hand. Thus, the functionality review and/or business driver assessment (discussed more fully below) may promote useful discussion which may tailor functionality to business needs. For example, extraneous functionality may be removed, or less important functionality may become a lower priority task on the implementation plan.

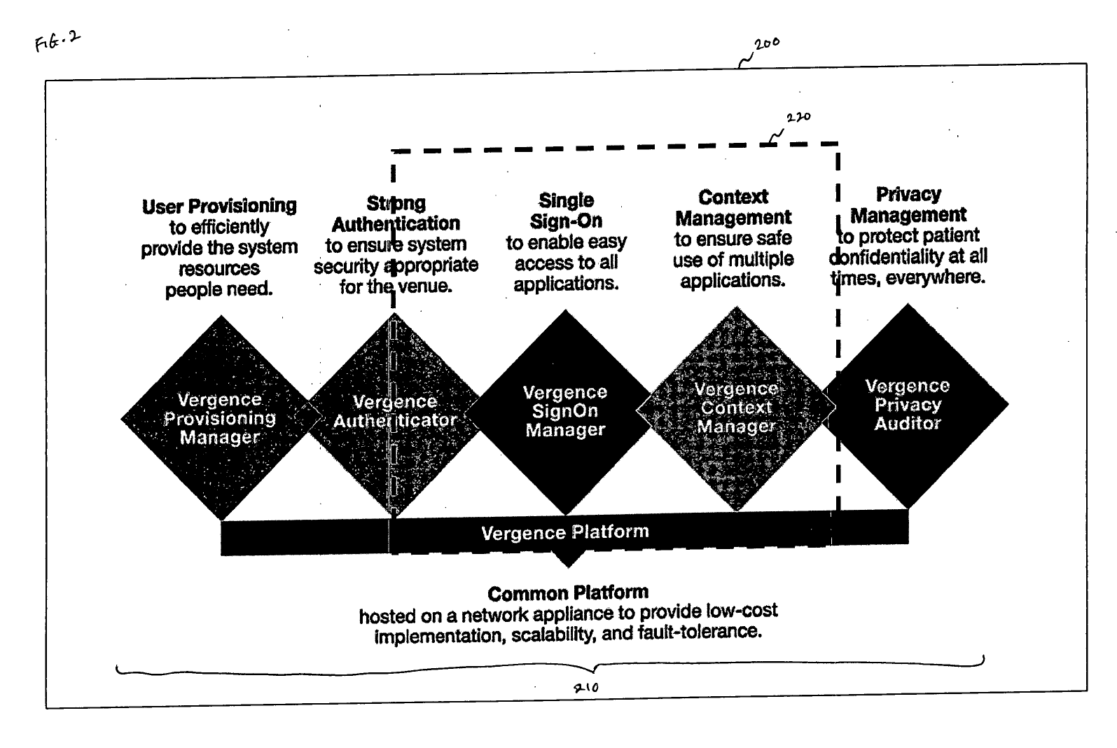

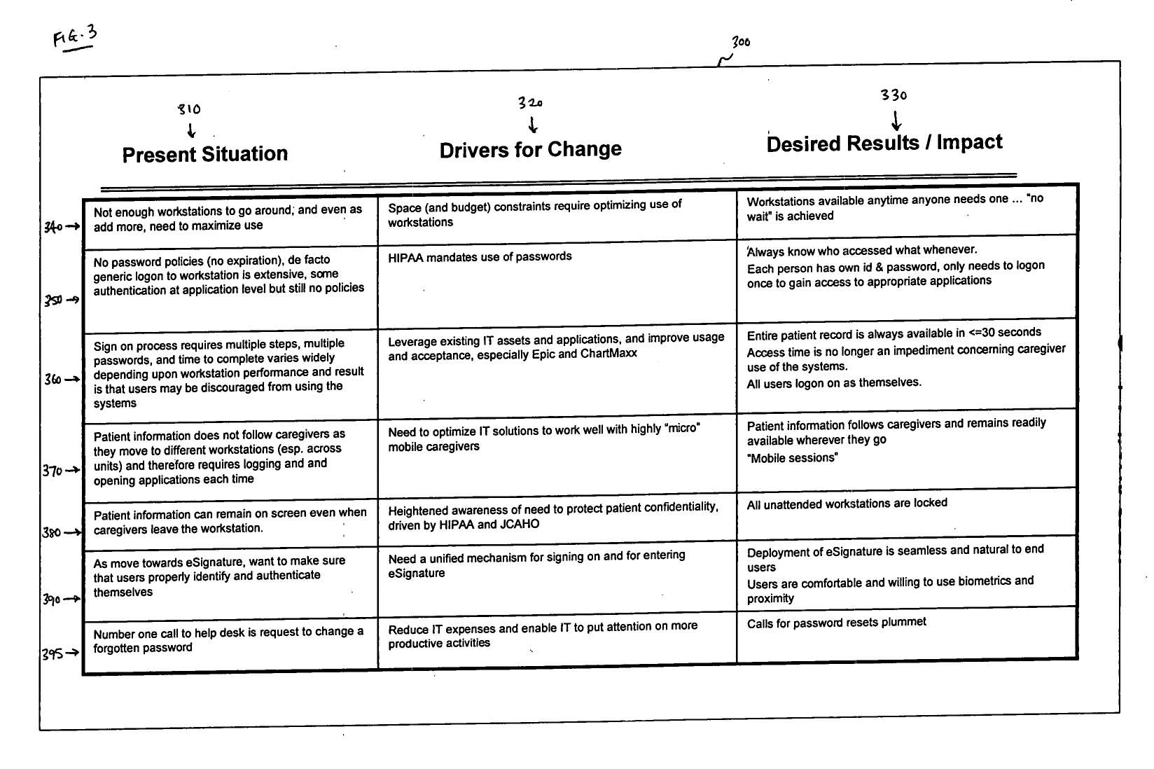

An illustrative article 200 which may be used to facilitate a functionality review is shown in FIG. 2. The article 200 (as well as the exemplary articles depicted in FIGS. 3-7, or any other article) may be provided in any suitable form, as the embodiments of the present invention disclosed herein are not limited to use with articles taking any particular form. For example, an article may be provided in hard copy (e.g., hand-rendered or -drawn) or electronic form. If provided in electronic form, the article may take any suitable electronic format. For example, the article may be provided as a word processing document, spreadsheet, presentation slide, drawing, or in any other suitable form.

In one embodiment, an article may, for example, be displayed to session attendees in a manner that promotes interactive discussion on the contents of the article. For example, an article may be displayed (e.g., on a whiteboard, using a projector on a computer screen) so that one or more attendees may view it, and a session facilitator may use the article to promote discussion on its contents. Further, attendees may participate in the session via telephone, video conference, the World Wide Web, or using any other suitable means. If it appears during the session that any changes should be made to the article (e.g., because of a point raised by a session attendee), the facilitator or any other suitable attendee may make changes, such as by providing input to a software application which accesses the article, by manually changing a hard copy or whiteboard version, or using any other suitable technique.

Article 200 includes portion 210, which provides an indication of the suite of product functionality which is available for purchase, and indicator 220, which identifies the functionality which was purchased by a hypothetical customer. The example of FIG. 2 relates to the Vergence® product suite, which is available from Sentillion, Inc. of Andover, Mass. In the example, the complete “Vergence Platform” suite of functionality shown in article 200 available for purchase includes the “Vergence Provisioning Manager”, “Vergence Authenticator”, “Vergence SignOn Manager”, “Vergence Context Manager”, and “Vergence Privacy Auditor” functionality. Indicator 220 identifies that the customer has purchased the “Vergence Authenticator”, “Vergence SignOn Manager” and “Vergence Context Manager” functionality. Of course, this is just an example, as an article may indicate that a customer has chosen different functionality and/or different software products. In addition, a selection of particular functionality need not be shown in the manner displayed in FIG. 2 (i.e., graphically with dotted lines enclosing the purchased functionality), and may be shown in any suitable manner.

After the functionality review, the process 100 (FIG. 1) continues with a facilitated assessment of the situation preceding the implementation (i.e., the present situation) and desired results or impacts in act 130. In act 130, the business issues which drove the purchase of the product, and the changes which the customer desires the product to bring about, may be uncovered and/or discussed.

As with act 120, act 130 may be performed using an article which is displayed to session attendees in a manner which promotes interactive discussion of the article's contents, or in any suitable way, as the aspects of the invention described herein are not limited in this respect. An exemplary article 300 for performing this assessment is shown in FIG. 3. Article 300 is a matrix having three columns 310 (“Present Situation”), 320 (“Drivers for Change”) and 330 (“Desired Results/Impacts”). Each row in the matrix contains information about a particular business issue the product was purchased to address. In the exemplary article 300 shown, the business issue reflected in row 340 is that there are insufficient workstations (reflected as a “present situation” in column 310), and that space and budget constraints require optimizing workstation use (reflected as a “driver for change” in column 320). The desired change to be brought about with the purchase and implementation of the product is that a workstation will be available anytime someone needs one (reflected as a “desired result/impact” in column 330). There are seven identified business issues included in article 300, such that there are seven rows 340-395 shown. Of course, the business issues shown in FIG. 3 are exemplary, and the aspects of the invention disclosed herein are not limited to being used with any of the issues shown. Further, an article used for assessing a situation preceding an implementation and/or desired results or impacts may provide any suitable information, as the invention is not limited in this respect. For example, the “drivers for change” shown in column 320 need not be shown.

The exemplary article 300 contains information relating to a particular implementation effort. In one embodiment, this information is generated by session attendees during the session. This may occur in any of numerous ways. For example, the session facilitator may develop a draft version of the business issues before the session occurs to engender discussion and review the draft information with session attendees, all of the information may be generated by the group during the session, or any other suitable technique may be used.

In one embodiment, information relating to the present situation (contained in column 310) and drivers for change (contained in column 320) are identified in tandem, as they may be closely related. For example, a particular driver, such as a business condition, may mandate that the present situation change. As an example, row 350 indicates that the Health Information Portability and Accountability Act (HIPAA) mandates the use of passwords, while the present situation is that no password policy exists. Thus, in this case, the driver mandates that the present situation change.

In one embodiment, once session attendees agree on the present situation and drivers for change with respect to the purchased product, and the appropriate information is captured in columns 310-320, the desired results or impacts of the implementation effort may be identified. Again, these may be identified via group discussion involving session attendees, by the facilitator in advance, or otherwise. Desired results and impacts may represent how the customer organization wishes the business issues reflected in columns 310 and 320 to change as a result of implementing the product.

A desired change shown in column 330 may be expressed quantitatively (i.e., as a “result”) and/or qualitatively (i.e., as an “impact”). The manner in which a desired change is expressed may depend on the present situation which is to be changed, and/or the driver for change. For example, the present situation reflected in row 360 is that the sign-on process requires multiple steps. This type of present situation may lend itself to a quantifiable change, such as the desired result, shown in column 330 at row 360, that a patient record is always available in thirty seconds or less. However, the present situation reflected in row 390, that as the organization moves toward “eSignature”, it makes sure that users properly identify themselves, may lend itself to a change that can best be evaluated qualitatively. As a result, a qualitatively expressed desired impact—that the deployment of eSignature is seamless and natural to end users—is shown in column 330 at column 370. Desired changes may be expressed qualitatively and/or quantitatively, or using any other suitable means of expression, as the invention is not limited in this respect.

In one embodiment, six to ten business issues are identified to make a session most productive. Specifically, if a lower number (e.g., two or three) is identified, there may be other unidentified issues which may affect the implementation of the product. Conversely, if a higher number is identified, the number of issues may become unwieldy and difficult to manage during the session and to track thereafter.

Process 100 continues with act 140, in which desired results and/or impacts identified in act 130 may be prioritized. For example, a facilitator of the session may lead a group discussion wherein attendees collectively prioritize the desired results and/or impacts, or this may be accomplished in any other suitable fashion.

In act 150, a summary (referred to herein as a “project dashboard”) may be developed to provide a summary view of actual and planned progress over time on the desired results and/or impacts which were prioritized in act 140. In one embodiment, the detailed implementation plan is developed subsequent to the session and is based on the project dashboard. Thus, the project dashboard may provide a tool for ensuring that the detailed implementation plan is tailored to achieve the desired results and/or impacts in the priority order defined by session attendees.

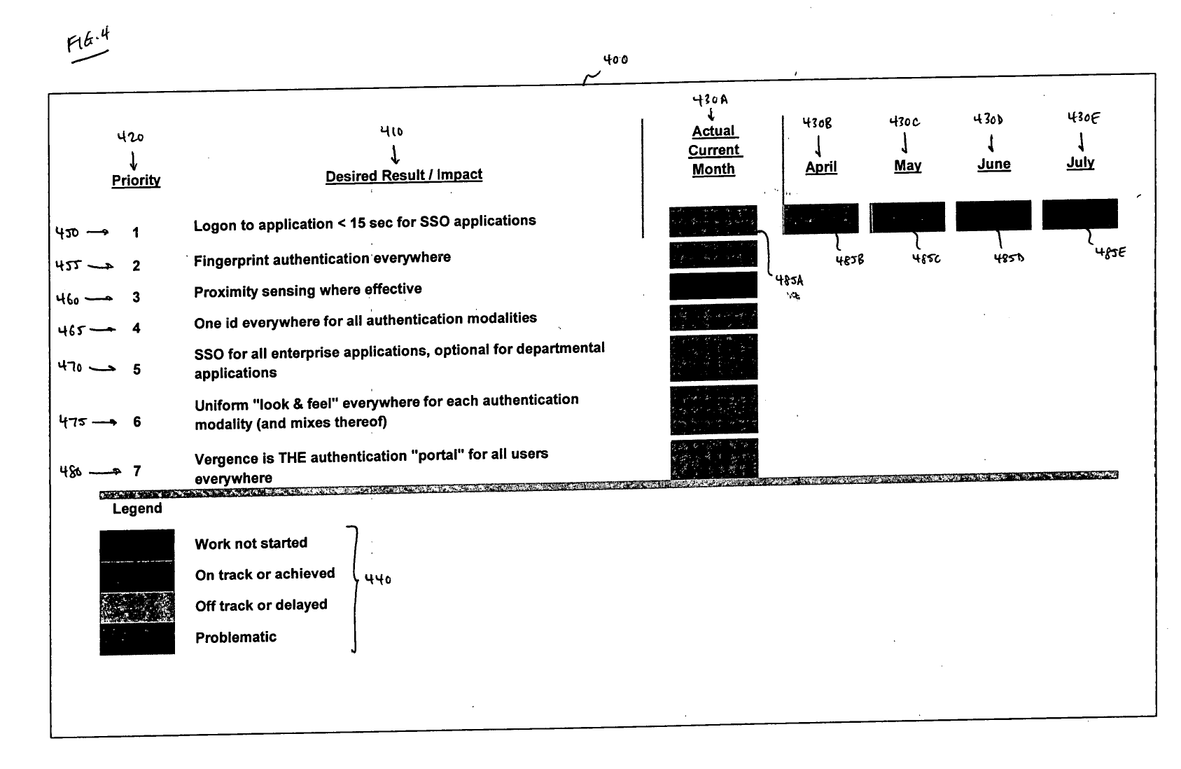

An exemplary project dashboard is illustrated as article 400, shown in FIG. 4. Article 400 provides information relating to desired results and/or impacts in matrix form. On the exemplary article shown, each desired result or impact is listed in a separate row entry 450-480 at column 410, in an order defined by the priority shown for each row entry at column 420. Of course, information may be provided in any suitable manner (e.g., the information need not be provided in rows and/or columns, or in any particular order), as the invention is not limited in this respect. The planned progress for each entry is shown at columns 430A-430E. That is, for each entry, an indicator 485 shows the progress associated with the desired result or impact in row 450. An indicator 485 is provided for the current month and four prospective months, and legend 440 indicates the information conveyed by indicator 485. Thus, indicator 485 shows that progress associated with the desired result shown in row 450 is “on track or achieved” in the current month and the four prospective months reflected in this exemplary dashboard. As shown in legend 440, an indicator may show planned and actual progress for a desired result or impact in any of four ways (i.e., “Work not started”, “On track or achieved”, “Off track or delayed” and “Problematic”). Embodiments may alternatively employ any suitable indicator, as the invention is not limited in this respect.

It should be appreciated that information on progress associated with desired results or impacts need not be shown in matrix form as in article 400. Any suitable technique for conveying this or other information may be employed. Further, as with articles 200 and 300 (FIGS. 2 and 3), article 400 may be developed in any suitable fashion. For example, article 400 may be developed based on a group discussion during the session, using the article as a vehicle to facilitate the discussion, or in any other way.

In one embodiment, a project dashboard may serve as a vehicle for ongoing dialogue between representatives of the customer and supplier organizations. For example, the project dashboard may serve as a status report which is periodically reviewed by customer and supplier executives. In one embodiment, a facilitator may request during the session that customer and supplier executives agree on an interval at which the project dashboard will be reviewed. At the agreed upon frequency, customer and supplier executives may review actual and planned progress on each desired result and/or impact, and may reprioritize results and/or impacts where appropriate. As a result, the project dashboard may become a “living document” which is modified over the course of an implementation effort, and thus may be a useful artifact from the session.

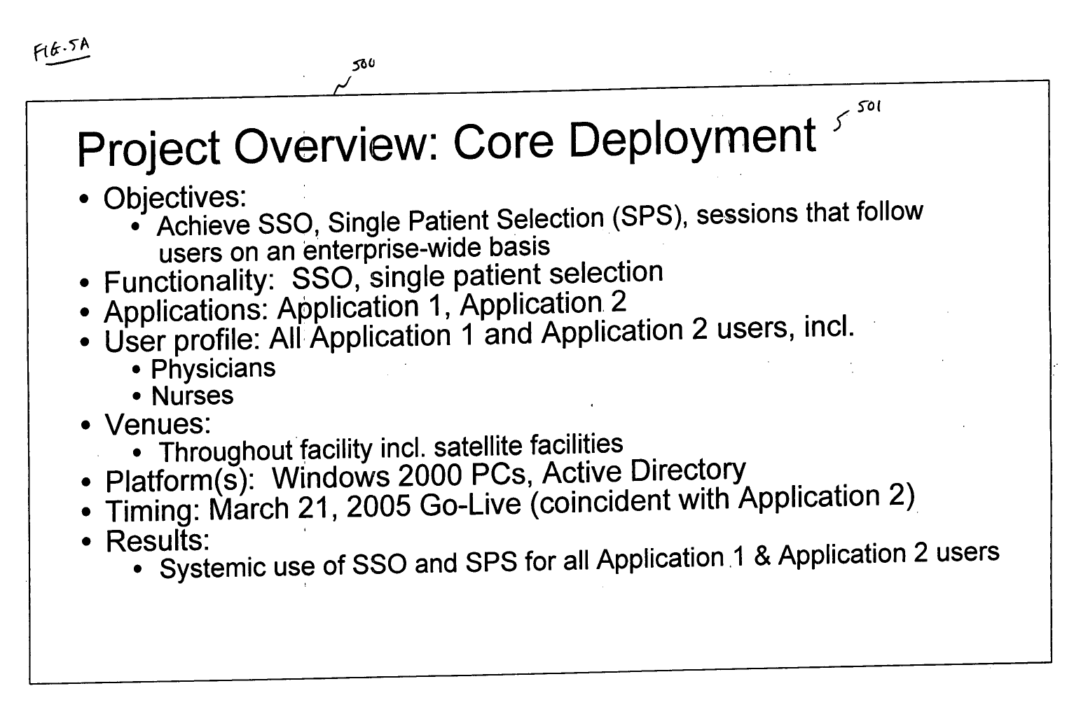

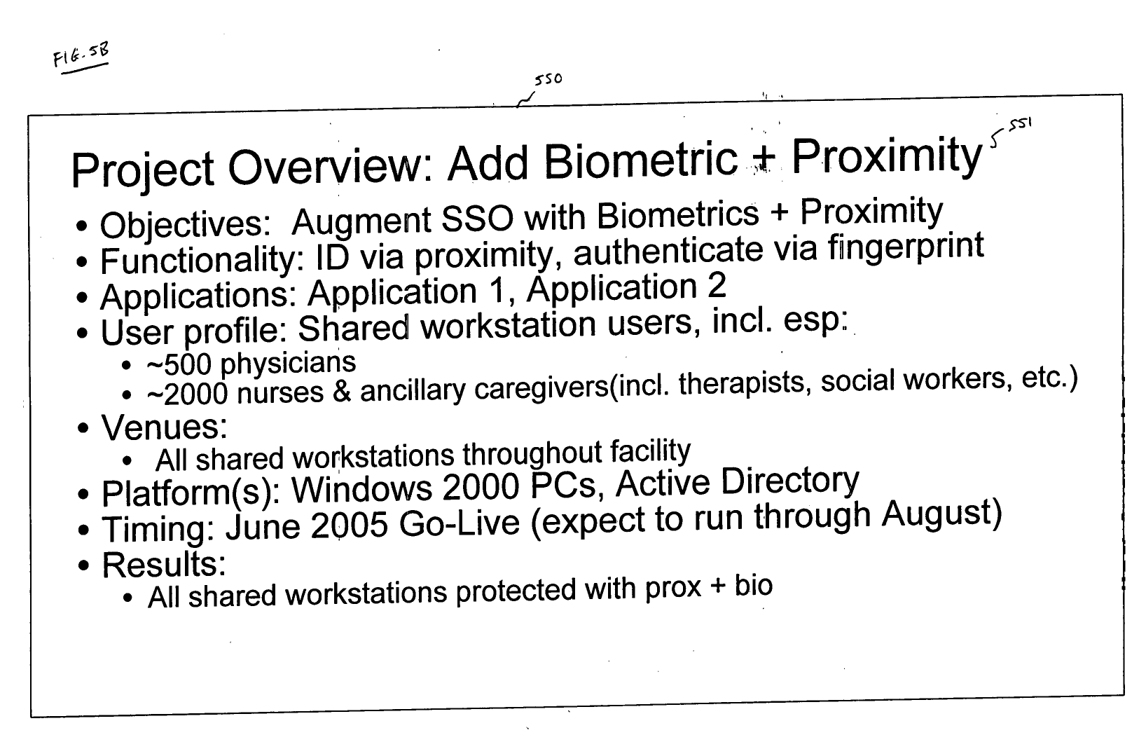

The process 100 continues with act 160, wherein one or more project overview articles (e.g., documents) are developed. Exemplary project overview articles are shown in FIGS. 5A-5B. As with the articles described above, a project overview article may be developed via facilitated group discussion, or in any other suitable manner. In one embodiment, each individual project overview article provides summary-level information on a particular aspect of the implementation project. For example, article 500 (FIG. 5A) provides information on an aspect of the effort entitled the “Core Deployment” in title 501, while article 550 (FIG. 5B) provides information on an “Add Biometric and Proximity” aspect of the effort, reflected in title 551. Of course, these aspects are merely examples, and may vary from project to project. In the illustrative embodiments shown, a project overview article provides information on the considered aspect of the project, including one or more objectives, the functionality desired, the product(s) affected, the users affected, the platform on which the products execute, and the projected timing (i.e., completion). Each of these pieces of information is described more fully below. However, it should be appreciated that these pieces of information are merely exemplary, as any information may be employed. The invention is not limited in this regard.

Applicants have appreciated that because a purchased software product may require integration with existing (i.e., already installed) applications, and because applications identified prior to the session (e.g., during the sales process) may not be complete, it may be useful to identify the existing applications during the session and record them in the project overview article. For example, article 500 identifies “Application 1” and “Application 2” as existing applications with which the purchased product may be integrated.

Applicants have also appreciated that implementation projects may be most successful when the functionality of the product being implemented and key user community contingents align. For example, if a particular aspect of the implementation effort is designed to implement a particular module of the product which is not designed for use by the user contingent for which it is intended, then the implementation effort may encounter obstacles. Thus, in one embodiment, steps are taken to ensure that functionality and user contingents align during the session, and to record the user contingents in the project overview article.

Applicants have further appreciated that implementation projects may be most successful when the platform on which the user community will access the product is confirmed. For example, if it is determined during the session that the devices used by a particular contingent execute a particular operating system and the product does not run on that operating system, the implementation effort may encounter obstacles. Thus, in one embodiment, the device(s) and/or operating system(s) on which the product will execute are identified.

In one embodiment, the anticipated completion date for the considered project aspect is recorded, to establish a common understanding among session attendees. For example, it may be useful for both customer and supplier representatives to agree on a completion date.

Any suitable information may be recorded on a project overview article, as the invention is not limited in this respect. In one embodiment, information such as the number of users to be served by the product, the physical venues where user contingents are located (e.g., to identify connectivity and networking issues), and/or other information is identified.

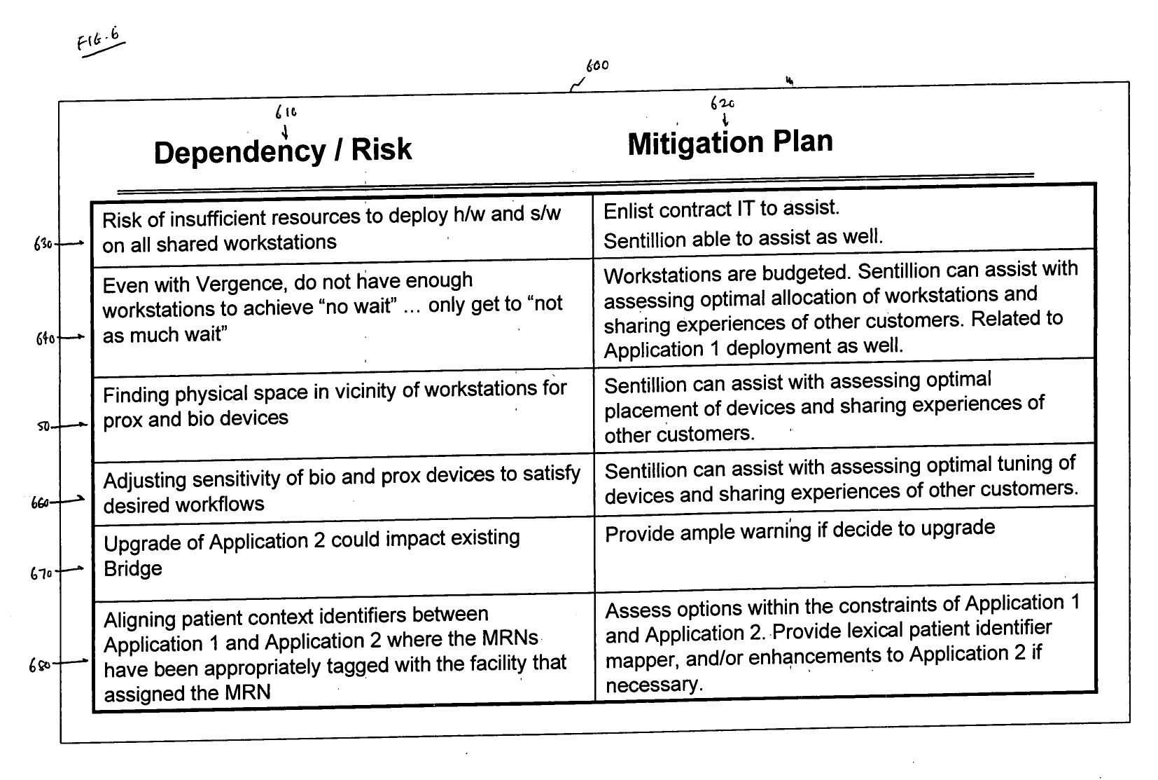

Process 100 continues with act 170, in which project dependencies and/or risks are identified. Act 170 optionally includes defining a mitigation plan for each identified dependency and/or risk. This information may, for example, be recorded during the session on an article, such as exemplary article 600 which is shown in FIG. 6. Article 600 includes two columns 610 and 620, in which dependencies and/or risks and mitigation plans are shown, respectively, and each of rows 630-680 includes a particular dependency and/or risk and an associated mitigation plan. This format of columns and rows is merely illustrative, and the invention is not limited to any particular format.

Any suitable information may be stored in article 600. For example, key technical dependencies may be included. Session participants may identify technical or logistical issues associated with the implementation effort, such as, for example, identifying a power source for the data center in which the product may execute, ensuring that physical space exists in the location at which components are to be implemented, or any other issue. In the exemplary article 600 shown, a mitigation plan is established for each identified dependency and/or risk. Each mitigation plan may be defined, for example, via facilitated group discussion during the session, or using any other suitable technique.

Applicants have appreciated that a listing which includes six to twelve dependencies and/or risks may be most effective in orienting the group. As with the listing of business issues produced in act 130, a listing of dependencies and/or risks having more than twelve entries may become unwieldy, while a listing having fewer then six entries may not fully address the potential issues facing the project. However, the invention is not limited in this respect, as any suitable number may be identified.

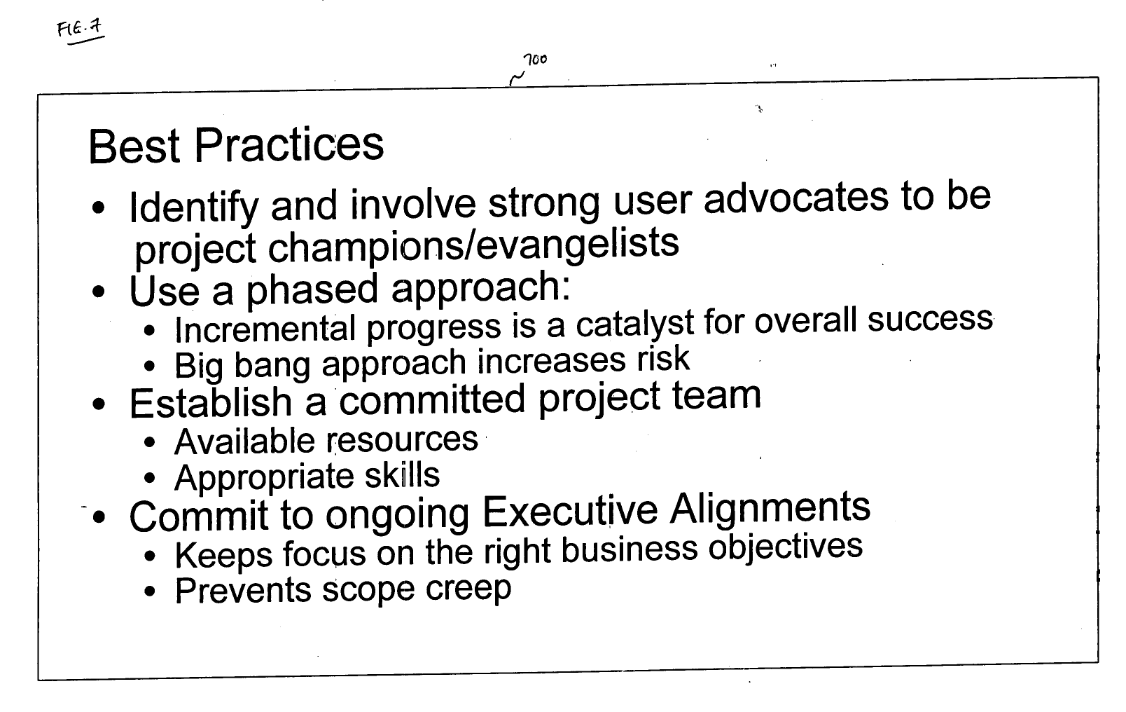

Process 100 continues with act 180, in which general-purpose best practices are identified. Applicants have appreciated that implementation efforts may be most successful when they comply with generally accepted best practices for software implementation efforts. Best practices may, for example, be based on the collective experience of supplier representatives, or session attendees as a whole. One or more identified best practices may be recorded during the session in an article, such as exemplary article 700 shown in FIG. 7. An article may include a list of best practices, such as (as shown in article 700) dedicating a full-time team to the implementation effort, ensuring executive-level commitment to the overall effort and ongoing project reviews, and/or any other suitable best practices. Article 700 may take any suitable form and display any suitable information, as the invention is not limited in this respect.

Upon the completion of act 180, process 100 completes.

It should be appreciated that process 100 is merely exemplary, and that a process performed in accordance with embodiments of the invention may include more, less or different acts than those described in the foregoing. Further, acts may be performed in any suitable sequence, as the invention is not limited in this regard.

In one embodiment of the present invention, upon the conclusion of process 100, a representative from the supplier organization may deliver one or more artifacts (e.g., any of articles 200-700) from the session to customer representatives. The artifacts may be delivered in any suitable way. For example, if articles 200-700 were developed during the session in electronic format, the supplier representative may send the article(s) via email.

The supplier representative may also, or alternatively, draft a memo to a customer representative which summarizes one or more of the key points discussed in the session. An exemplary memo is provided in Appendix A. In one embodiment, the memo may document one or more of the key points discusses in the session. The memo may also, as an example, attach a copy of a project dashboard article developed during the session.

In one embodiment, any associated materials may be delivered to the customer organization shortly after the session is completed (e.g., about a week or less later), and shortly after delivery occurs, verbal contact may be initiated with the customer organization to confirm that the materials were received and inquire whether there are questions regarding the materials. The representative from the supplier organization may confirm, for example, a frequency at which executives from each organization will convene or speak to review an updated project dashboard and review the status of the implementation effort.

As discussed above, one embodiment of the present invention relates to a method for facilitating deployment of the software product performed after the product has been sold by a supplier organization to a customer organization, and includes convening a group comprising at least one representative from the customer organization having an understanding of one or more executive level business goals which motivated the customer organization to purchase the software product, and assessing, by the group, the one or more executive level business goals and the ways in which the software product can be implemented to achieve at least some of them. The executive level business goals that may be assessed may include a wide variety of business goals, as the aspects of the present invention described herein are not limited in this respect.

Further, aspects of the invention may be employed with customer organizations of numerous types, which seek to achieve numerous types of executive level business goals via the purchase of a software product. Some examples of executive level business goals which may be assessed by the group will now be described, but it should be appreciated that this list is merely illustrative and is not intended as exhaustive or limiting.

One example of an executive level business goal which a customer organization may desire to achieve via the purchase of the software product is compliance with one or more governmental regulations. In this respect, numerous types of government regulations may be relevant. Examples may include Sarbanes-Oxley, rules and/or regulations issued by the Security and Exchange Commission (SEC), the Health Insurance Portability and Accountability Act (HIPAA), and the Personal Health Information Protection Act (PHIPA) enacted in Canada.

Other examples of executive level business schools may include reducing costs and/or accelerating revenue growth for a customer organization. Further examples of executive level business goals include improving information technology (IT) system performance, IT system reliability and/or IT system security. Still further examples include improving user satisfaction and/or workflow within the customer organization through the use of a newly purchased software product.

Examples of executive level business goals further include achieving industry leadership in one or more areas, automating business processes within the customer organization, addressing competitive threats to the customer organization, and pioneering new technologies, new business opportunities, and/or new business models.

Finally, another example of an executive level business goal is responding to a directive or mandate from the board of directors or the chief executive officer (CEO) of the customer organization.

As mentioned above, the executive level business goals discussed above are merely examples of those which might be assessed by a group in accordance with one embodiment of the present invention. Numerous other types of executive level business goals may be assessed. In addition, it should also be appreciated that a method performed in accordance with one embodiment of the present invention contemplates a group assessing any one executive level business level goal in relation to the implementation of a software product, or assessing any two or more executive level business goals in combination.

It should be appreciated that the aspects of the present invention described herein may be employed with customer organizations of numerous types and sizes, as the aspects of the present invention described herein are not limited in this respect. In accordance with one embodiment, it is contemplated that aspects of the present invention may be employed with a customer organization that comprises at least one individual (who may be a senior executive in the customer organization) whose responsibilities may generally include the procurement, implementation and ongoing maintenance of commercial software technology for the purpose of supporting the business. Such an individual may hold a title of chief information officer (CIO) or an equivalent title, and may report directly to the organization's chief executive officer (CEO), chief operating officer (COO), chief financial office (CFO) or the board of directors. The at least one responsible individual may manage and direct a team comprised of information technology managers, architects, developers and support staff, which may be comprised of employees of the customer organization and/or consultants and/or outsourced staff. The one or more individuals responsible for the implementation of the software product also may be an employee, consultant, or a member of an outsourced firm.

In accordance with one embodiment of the present invention, an executive alignment may include, in addition to a representative from the customer organization having an understanding of the executive level business goals that motivated the customer organization to purchase the software product, the one or more individuals responsible for the procurement, implementation and maintenance of commercial software technology for the customer organization, as well as one or more members of his/her team.

In a further embodiment, an executive alignment may include members of a community of individuals at the customer organization who will use the procured software to perform business functions.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for facilitating a deployment of a software product, the method including acts, performed after the software product has been sold by a supplier organization to a customer organization, of:
(A) convening a group which includes at least one representative from the supplier organization and at least one representative from the customer organization, the at least one representative from the customer organization having an understanding of one or more executive level business goals that motivated the customer organization to purchase the software product; and
(B) assessing, by the group, the one or more executive level business goals and ways in which the software product can be implemented at the customer organization to achieve at least some of the one or more executive level business goals.

2. The method of claim 1, wherein the act (A) is initiated by the supplier organization.

3. The method of claim 1, where the act (A) comprises convening a group which includes at least one representative from the customer organization responsible for implementing the software product.

4. The method of claim 1, wherein the act (B) comprises performing a review of functionality provided by the software product purchased by the customer organization.

5. The method of claim 1, wherein the act (B) comprises performing an assessment of a present situation at the customer organization, one or more drivers for change at the customer organization, and desired results and/or impacts for the implementation of the software product at the customer organization.

6. The method of claim 5, wherein the act (B) comprises performing, for each of a number of aspects of the implementation, an assessment of the present situation at the customer organization, the one or more drivers for change at the customer organization, and the desired results and/or impacts for the implementation of the software product at the customer organization, the number of aspects of the implementation being equal to at least five and less than twelve.

7. The method of claim 5, wherein the act (B) comprises, when a plurality of desired results and/or impacts are identified, prioritizing the plurality of desired results and/or impacts.

8. The method of claim 5, further comprising an act of producing a dashboard providing information relating to each of the desired results and/or impacts.

9. The method of claim 1, wherein the act (B) comprises identifying at least one dependency and/or risk associated with the implementation.

10. The method of claim 1, wherein the act (B) comprises performing a review of product implementation best practices.

11. The method of claim 1, wherein the functionality provided by the software product relates to health care.

12. The method of claim 1, wherein the act (A) comprises convening a group which includes at least one representative of the supplier organization responsible for supporting the at least one representative of the customer organization responsible for implementing the software product.

13. The method of claim 1, wherein the act (B) further comprises facilitating, by the at least one representative from the supplier organization, the group's assessing.

14. The method of claim 1, further comprising an act of creating at least one article that facilitates the group's assessing.

15. The method of claim 14, wherein the creating of the at least one article comprises receiving input from members of the group on information to be included in the at least one article.

16. The method of claim 15, wherein the act of creating the at least one article comprises acts of:
before the act (B), preparing a template of the article; and
during the act (B), adding information to the template of the article.

17. The method of claim 1, wherein the customer organization includes at least one representative whose primary responsibility relates to information technology.

18. A method for facilitating an implementation of a software product including acts, performed after the software product is sold by a supplier organization to a customer organization and before the software product is implemented, of:
(A) convening a group which includes a representative from the supplier organization and a representative from the customer organization, the representative from the customer organization being empowered by the customer organization to make a decision related to an allocation of customer organization resources to the implementation; and
(B) upon convening the group, performing at least one task from a plurality of tasks which includes:
(1) performing an review of functionality provided by the software product;
(2) performing an assessment of a present situation, a driver for change, and a desired result or impact, with respect to each of a plurality of aspects of the implementation;
(3) prioritizing the plurality of desired results or impacts which are assessed in task (2);
(4) producing a dashboard for the implementation, the dashboard providing information relating to each of the desired results or impacts assessed in task (2);
(5) producing an overview for an aspect of the implementation;
(6) identifying at least one dependency or risk associated with the implementation; and
(7) performing a review of product implementation best practices;
wherein the functionality provided by the software product relates to health care.

19. The method of claim 18, wherein the act (A) further comprises convening a group which includes members of the customer organization responsible for performing the implementation.

20. The method of claim 18, wherein the act (A) further comprises convening a group which includes members of the supplier organization responsible for working with members of the customer organization to perform the implementation.
